(19) United States
(12) Patent Application Publication
(10) Pub. No.: US 2018/0357302 A1
(43) Pub. Date: Dec. 13, 2018

(54) METHOD AND DEVICE FOR PROCESSING A TOPIC

(71) Applicant: Beijing Gridsum Technology Co., Ltd., Beijing (CN)

(72) Inventors: Guosheng Qi, Beijing (CN); Wenbin Xu, Beijing (CN)

(21) Appl. No.: 16/060,657

(22) PCT Filed: Dec. 8, 2016
(86) PCT No.: PCT/CN2016/109066

§ 371 Date: Jun. 8, 2018

(30) Foreign Application Priority Data
Dec. 11, 2015 (CN) 201510921239.7

(51) Int. Cl. G06F 17/30

(52) U.S. Cl. CPC G06F 17/30616; G06F 17/30368; G06F 17/30734; G06F 17/3071

(57) ABSTRACT

Provided are a method and device for processing a topic. The method includes: a newly-added text for describing a topic is acquired (S102); whether the topic described in the newly-added text is an existing topic is detected (S104); and when a detection result is that the topic described in the newly-added text is not an existing topic, it is determined that the topic described in the newly-added text is a newly-added topic (S106). The method solves a technical problem in the related art where only an existing topic can be discovered whilst a new topic cannot be discovered.

### TECHNICAL FIELD

The present application relates to the field of natural language processing, and more particularly to a method and device for processing a topic.

### BACKGROUND

A topic detection and tracing technology is a highly practical technology in the field of natural language processing and information retrieval, and also a practical technology of effectively discovering and extracting useful information in the context of big data, intended to discover and process a hot topic or event in a text. Usually, a discovery and tracing technology for a hot topic or report is a technology of discovering and tracing subsequent progression of the topic for a specific field or a specific event.

At present, a hot topic detection technology at home and abroad mainly focuses on topic discovery, filtration and tracing from various news reports. The execution process is as follow: 1. text acquisition, i.e., collecting news reports from various media through the Internet; 2. text vectorization, i.e., vectorizing the collected original texts to form vectorized texts; 3. text clustering, i.e., performing clustering analysis on the vectorized texts, and taking a frequently occurring term or a text in a clustering center as a topic; and 4. repeating the steps 1, 2 and 3 within a specific time period, sorting the topics obtained in the step 3 by using a hotness model, and outputting the top-n topics. Although achieving topic discovery and tracing functions, the execution process has the following defects: (1) offline processing cannot discover and trace a new topic in real time, so that a new topic event cannot be effectively understood in time; (2) an information source is single, where all pieces of information come from news reports and other resources such as Weibo and forums cannot be effectively utilized; (3) a new topic occurring in a text cannot be adaptively discovered, and an existing specified topic using and clustering technology for discovering and tracing topics in a series of texts cannot be applied to sudden topics and developing topics; and (4) the text clustering method is a coarse processing method, which cannot fully express an important element of a topic, so that the utilization rate of effective information in a text is insufficient, and a topic occurring in the later stage will be subjected to class-center offset.

Any effective solution has not been proposed yet at present for the above-mentioned problem.

### SUMMARY

The embodiments of the present disclosure provide a method and device for processing a topic, intended to at least solve a technical problem in the related art where only an existing topic can be discovered whilst a new topic cannot be discovered.

According to an aspect of the embodiments of the present disclosure, a method for processing a topic is provided, comprising: acquiring a newly-added text for describing the topic; detecting whether the topic described by the newly-added text is an existing topic; and when a detection result is that the topic described by the newly-added text is not the existing topic, determining that the topic described by the newly-added text is a newly-added topic.

According to an example embodiment, acquiring the newly-added text for describing the topic comprises: online acquiring the newly-added text for describing the topic.

According to an example embodiment, acquiring the newly-added text for describing the topic comprises: acquiring, from a plurality kinds of information sources, the newly-added text for describing the topic.

According to an example embodiment, after determining that the topic described by the newly-added text is the newly-added topic, the method further comprising: adding the newly-added topic as an existing topic; or, storing the newly-added text for describing the topic in a newly-added topic text queue, after the number of texts in the newly-added topic text queue reaches a preset value and/or a program execution time reaches a preset duration, extracting a corresponding newly-added topic from the newly-added topic text queue, and adding the extracted newly-added topic as an existing topic.

According to an example embodiment, after extracting the corresponding newly-added topic from the newly-added topic text queue and before adding the extracted newly-added topic as the existing topic, the method further comprising: filtering a noise topic from the extracted newly-added topic.

According to an example embodiment, after adding the newly-added topic as the existing topic, the method further comprising: searching the existing topics added with the newly-added topic for a hot topic, wherein the hot topic is a topic of which a rank reaches a preset threshold in the existing topics added with the newly-added topic; and outputting the hot topic.

According to an example embodiment, detecting whether the topic described by the newly-added text is the existing topic comprises: vectorizing the newly-added text to obtain a text vector of the newly-added text; creating a topic matrix of the existing topic, wherein each column of the topic matrix represents a topic, each row represents a term in the topic, and each element represents a weight of a current term in a current topic; constructing a function relationship Y=A*X of a text vector Y of the newly-added text according to a topic matrix A of the existing topic; determining a belonging relationship between the topic described by the newly-added text and the existing topic according to a solution of X; and determining whether the topic described by the newly-added text is the existing topic according to the belonging relationship.

According to another aspect of the present disclosure, a device for processing a topic is provided, comprising: an acquiring element, configured to acquire a newly-added text for describing the topic; a detecting element, configured to detect whether the topic described by the newly-added text is an existing topic; and a determining element, configured to, when a detection result is that the topic described by the newly-added text is not the existing topic, determine that the topic described by the newly-added text is a newly-added topic.

According to an example embodiment, the acquiring element is further configured to online acquire the newly-added text for describing the topic.

According to an example embodiment, the acquiring element is further configured to acquire from a plurality kinds of information sources the newly-added text for describing the topic.

According to an example embodiment, the device further comprising: a first adding element, configured to add, after it is determined that the topic described by the newly-added text is the newly-added topic, the newly-added text as an existing topic; or, a second adding element, configured to store the newly-added text for describing the topic in a newly-added topic text queue, extract, after the number of texts in the newly-added topic text queue reaches a preset value and/or a program execution time reaches a preset duration, a corresponding newly-added topic from the newly-added topic text queue, and add the extracted newly-added topic as an existing topic.

According to an example embodiment, the device further comprising: a filtering element, configured to filter, after the corresponding newly-added topic is extracted from the newly-added topic text queue and before the extracted newly-added topic is added as the existing topic, a noise topic from the extracted newly-added topic.

According to an example embodiment, the device further comprising: a searching element, configured to, after the newly-added topic is added as the existing topic, search the existing topics added with the newly-added topic for a hot topic, wherein the hot topic is a topic of which a rank reaches a preset threshold in the existing topics added with the newly-added topic; and an outputting element, configured to output the hot topic.

According to an example embodiment, the detecting element comprises: a processing component, configured to vectorize the newly-added text to obtain a text vector of the newly-added text; a creating component, configured to create a topic matrix of the existing topic, wherein each column of the topic matrix represents a topic, each row represents a term in the topic, and each element represents a weight of a current term in a current topic; a constructing component, configured to construct a function relationship Y=A*X of a text vector Y of the newly-added text according to a topic matrix A of the existing topic; a first determining component, configured to determine a belonging relationship between the topic described by the newly-added text and the existing topic according to a solution of X; and a second determining component, configured to determine whether the topic described by the newly-added text is the existing topic according to the belonging relationship.

In the embodiments of the present disclosure, a manner of adaptively discovering a new topic is adopted to achieve the aim of discovering a new topic and tracing an existing topic by acquiring a newly-added text for describing a topic, detecting whether the topic described in the newly-added text is an existing topic and determining that, when a detection result is that the topic described in the newly-added text is not an existing topic, the topic described in the newly-added text is a newly-added topic, so that a technical effect of improving the efficiency of topic discovery and accuracy is achieved, thereby solving a technical problem in the related art where only an existing topic can be discovered whilst a new topic cannot be discovered.

### BRIEF DESCRIPTION OF THE DRAWINGS

The drawings described herein are used to provide further understanding for the present disclosure and form a part of the present application. The schematic embodiments and descriptions of the present disclosure are used to explain the present disclosure, and do not form improper limits to the present disclosure. In the drawings:

FIG. 1 is a flowchart of an alternative method for processing a topic according to an embodiment of the present disclosure;

FIG. 2 is a block diagram of an alternative online adaptive topic discovery and tracing model according to an embodiment of the present disclosure; and

FIG. 3 is a schematic diagram of an alternative device for processing a topic according to an embodiment of the present disclosure.

### DETAILED DESCRIPTION OF THE EMBODIMENTS

In order to make those skilled in the art better understand the solutions of the present application, the technical solutions in the embodiments of the present application will be clearly and completely described below in conjunction with the drawings in the embodiments of the present application. Obviously, the described embodiments are only a part of the embodiments of the present application, not all of the embodiments. On the basis of the embodiments of the present application, all other embodiments obtained on the premise of no creative work of those skilled in the art shall fall within the scope of protection of the present application.

It is important to note that the description and claims of the present application and terms “first”, “second” and the like in the drawings are used to distinguish similar objects, and do not need to describe a specific sequence or a precedence order. It will be appreciated that data used in such a way may be exchanged under appropriate conditions, in order that the embodiments of the present application described here can be implemented in a sequence except sequences graphically shown or described here. In addition, terms “include” and “have” and any inflexions thereof are intended to cover non-exclusive inclusions. For example, processes, methods, systems, products or equipment containing a series of steps or units do not need to clearly show those steps or units, and may include other inherent steps or units of these processes, methods, products or equipment, which are not clearly shown instead.

### Embodiment 1

According to the embodiments of the present disclosure, a method embodiment of a method for processing a topic is provided. It should be noted that the steps shown in the flowchart of the drawings may be executed in a computer system including, for example, a set of computer-executable instructions. Moreover, although a logic sequence is shown in the flowchart, the shown or described steps may be executed in a sequence different from the sequence here under certain conditions.

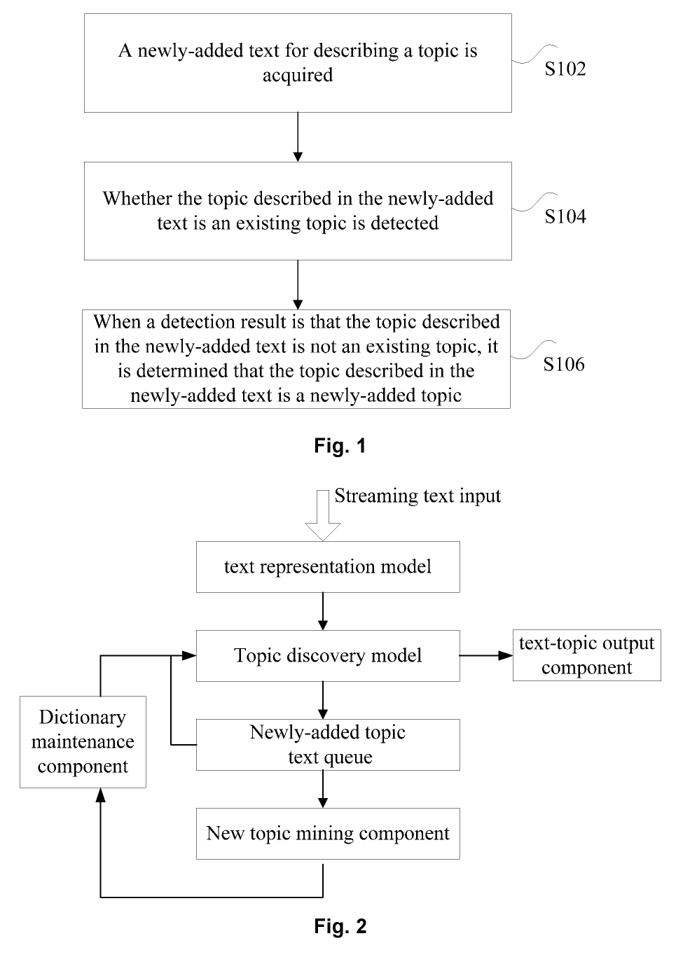

FIG. 1 is a flowchart of an alternative method for processing a topic according to an embodiment of the present disclosure. As shown in FIG. 1, the method includes the steps as follows.

In step S102, a newly-added text for describing a topic is acquired.

In step S104, whether the topic described in the newly-added text is an existing topic is detected.

In step S106, when a detection result is that the topic described in the newly-added text is not an existing topic, it is determined that the topic described in the newly-added text is a newly-added topic.

During implementation, various parameters of an online adaptive topic discovery and tracing model for streaming batch processing are initialized, a newly-added text for describing a topic in the specified field in all information sources is monitored in real time by means of a crawler technology, a topic in the text is extracted, and it is detected whether the extracted topic is an existing topic, wherein when the extracted topic is an existing topic, it is determined that the topic described in the newly-added text is a newly-added topic (namely new topic); and when the extracted topic is not an existing topic, it is determined that the topic described in the newly-added text is an existing topic, that is, there is not a newly-added topic currently. In addition, a manner of mining a topic (namely subject) in a text may be flexible selection, which will not be limited herein. Moreover, an existing topic may be specified artificially or obtained by adaptively adding a newly-added topic. In use, the existing topic may be stored in an existing topic list, so as to form a topic dictionary applied to a topic detection task for a newly-added text.

By means of the above-mentioned embodiment, a topic occurring in each information source is discovered by using an adaptive topic discovery technology, so that a new topic may be discovered and an existing topic may be traced, thereby improve the efficiency and accuracy of topic discovery.

As an alternative embodiment, acquiring the newly-added text for describing a topic comprises: acquiring the newly-added text for describing a topic on line. Specifically, a newly-added text for describing a topic may be crawled on line in real time by means of the crawler technology, and particularly, a newly-added text in the specified field is crawled by using the crawler technology.

By means of the embodiment of the present disclosure, an online text acquisition mode is adopted to overcome the defect in the related art where a new topic cannot be discovered and traced in real time and a new topic event cannot be effectively understood in time due to adoption of an offline processing mode, thereby being more applicable to constantly changing working scenarios of internet information, and focusing on a topic in a text in time.

As an alternative embodiment, the operation of acquiring a newly-added text for describing a topic comprises: the newly-added text for describing a topic is acquired from a plurality kinds of information sources. Specifically, the newly-added text for describing a topic in the specified field may be acquired from plurality kinds of information sources. The plurality kinds of information sources involved here may include: forums, news portals, Weibo and the like.

By means of the embodiment of the present disclosure, topic discovery and tracing can be achieved among multiple queries, thereby overcoming the defects in the related art where the information source is single and other effective resources such as Weibo and forums due to the fact that all pieces of information come from news reports.

Based on the above-mentioned implementation manner, alternatively, after it is determined that the topic described in the newly-added text is a newly-added topic, the method further comprises the steps as follows. (1) The newly-added text is added into the existing topic. Or, (2) the newly-added text for describing a topic is stored in a newly-added topic text queue, after the number of texts in the newly-added topic text queue reaches a preset value and/or a program execution time reaches a preset duration, a corresponding newly-added topic is extracted from the newly-added topic text queue, and the extracted newly-added topic is added as an the existing topic.

Compared with (2), (1) may update a topic dictionary storing an existing topic in time, may improve the capability of adaptively discovering and tracing a hot topic, but probably causes a large resource overhead due to over-frequent update. Compared with (1), (2) may update newly-added topics into a topic dictionary in batches, may save resource overheads occupied for update, but is insufficient in capability of topic discovery and tracing due to update lag.

In addition, a newly-added topic extraction operation is also involved in (2), and a topic model may be used to extract and represent a newly-added topic. Specifically, after a filtered text containing a new topic is obtained from a newly-added topic text queue, a topic model may be introduced to mine a topic contained in a text, and a vector which can be added into a topic discovery model and represents this topic is constructed according to different term sets used for representing a topic in a text. In view of that a sparse representation frame is used in the topic discovery model and sparse representation is a signal factorization operation originally, in order to keep consistency, not only a Non-negative Matrix Factorization (NMF) topic model may be used. Moreover, in different fields or different scenarios, other topic models may be better represented. For example, an LDA model, a Recurrent Neural Network (RNN) topic model and other models may complete this task. The principle of the NMF topic model is introduced as follows.

NMF is defined as follows. Non-negative matrices W and H are found, such that V=WH, where the matrix V represents an original text set, each column thereof representing a text; W and H are two non-negative matrices, where each row of the matrix W represents a feature item, each column represents a topic, the significance of each column in the matrix W is similar to a tuple in a topic dictionary, each column in the matrix H is similar to X in sparse representation, and each dimension of the column represents a relationship between a current text and an existing topic term. It should be noted that the number of potential semantic clusters contained in the matrix W may be limited herein, the number being the number of potential semantic clusters obtained by coarse clustering.

The NMF process is simply described as follows.

(1) when a noise matrix is E∈R^{n×m}, E=V−WH, and a WH solution process is a process of finding appropriate WH to minimize E.

(2) when noise obeys Gaussian distribution (or Poisson distribution),

a maximum likelihood function is:

$$ln L ( W , H ) = {\sum }_{i , j} ln \frac{1}{\sqrt{2 π} {σ}_{ij}} - \frac{1}{{σ}_{ij}} \cdot \frac{1}{2} {\sum }_{i , j} {[ {V}_{ij} - {( WH )}_{ij} ]}^{2}$$

a target function is:

$$J ( W , H ) = \frac{1}{2} {\sum }_{i , j} {[ {V}_{ij} - {( WH )}_{ij} ]}^{2}$$

(3) WH is solved by using a gradient descent method:

Wᵢₖ=Wᵢₖ−α₁·[(VH^{T})ᵢₖ−(WHH^{T})ᵢₖ]

Hₖⱼ=Hₖⱼ−α₂·[(W^{T}V)ₖⱼ−(W^{T}WH)ₖⱼ]

(4) The final simplification is:

$${W}_{ik} = {W}_{ik} \cdot \frac{{( {VH}^{T} )}_{ik}}{{( {WHH}^{T} )}_{ik}}$$

$${H}_{kj} = {H}_{kj} \cdot \frac{{( {W}^{T} V )}_{kj}}{{( {W}^{T} WH )}_{kj}}$$

After the matrix W is solved, the number of terms contained in a topic may be automatically selected for each column according to an importance threshold (namely weight) of a term set in a topic mining model, some terms with low weight in each column of W will be filtered out to remain terms with high weight, and therefore the remained terms may well represent a topic.

Further, after a topic is mined, it is not necessary to add all topics into an existing topic by serving as a newly-added topic. For example, some semantic clusters with small topic term sets and small weight may be abandoned as noise topics according to term characteristics in a current topic, the similarity between each of the remaining semantic clusters and the existing topic is then calculated, and it is determined whether to add the newly-added topic into the existing topic according to the magnitude of similarity finally. Herein, in the embodiments of the present disclosure, there may be multiple similarity calculation methods, and a cosin similarity calculation method is simply introduced below.

$$similarity = cos ( θ ) = \frac{A \cdot B}{‖ A ‖ ‖ B ‖} = \frac{{\sum }_{i = 1}^{n} {A}_{i} \times {B}_{i}}{\sqrt{{\sum }_{i = 1}^{n} {( {A}_{i} )}^{2}} \times \sqrt{{\sum }_{i = 1}^{n} {( {B}_{i} )}^{2}}}$$

When the similarity is more than 0.9, it is regarded that the current topic is an existing topic, and otherwise, it is regarded that the current topic is a newly-added topic instead of the existing topic and it is necessary to add it into a topic matrix by serving as a column.

By means of the embodiment of the present disclosure, a new topic may be adaptively discovered and added into a topic dictionary for subsequent topic discovery and tracing flows, and a topic model may discover a newly-added topic during detection of the attribution of a text topic by serving as an online adaptive learning model, and add the newly-added topic into the existing topic so as to meet adaptive increase of a topic list, so that loss of a new topic cannot be caused, and the problem that other methods cannot be used for incrementally processing of a new topic is effectively solved.

With the increase of the number of discovered newly-added topics, topics in the topic dictionary will be increasing. Because topics occur within a certain time period, after a topic occurs, this topic is still effective within a certain time period thereafter. However, existing topics in the topic dictionary will not occur at the same time within a certain time period. Based on this, when it is still necessary to operate those non-occurring topics during operation, resource overheads will be increased, and the operation speed is reduced. Preferably, during implementation, the number of topics in the topic dictionary may be limited to a fixed constant range. So, some topics which will not occur recently may not be operated by a text topic discovery model, thereby reducing unnecessary redundancy. Moreover, the operation rate and accuracy of some topics occurring for a long time and topics occurring recently can be ensured, thereby improving the operation efficiency and accuracy of the whole system. During implementation, a newly-added topic discovered already may be scheduled into an online processing procedure by using a most recently used scheduling algorithm. The idea of this scheduling algorithm is introduced below.

A data structure stack is introduced first, and a topic in a current working frame (namely procedure) and the number of occurrences of this topic within a certain previous time period are recorded by using this structure stack. The maximum number of topics accommodated by this stack is n_max, and the minimum number is n_min. When a most recently used scheduling algorithm is operated, when a topic occurs and this topic exists in a current stack, the topic is pulled out and a push operation is then executed, so a topic occurring recently is at the top of the stack, and those topics not occurring for a long time will occur at the bottom of the stack. It will be discovered that topics are sorted according to a descending order of occurrence count within a current time period from the top of the stack to the bottom of the stack by observing topics therein. After a topic in the stack meets a threshold, namely after the number of elements in the stack reaches n_max, topics in an existing working frame will be re-adjusted when a new topic occurs, that is, the number of topics in the stack is adjusted as n_min, so a topic which most frequently occurs recently and lasts for a long time may be filled in a blank in the stack, wherein after adjustment is completed, an existing topic discovery model may be updated.

In addition, the stack may actually utilize a fixed value, so every time a topic is newly added, it is necessary to perform scheduling once, thereby making scheduling over-frequent. By using a buffer of which the size is n_max−n_min, a tuple in a working dictionary may be adaptively selected, and a tuple in a non-working dictionary is placed out, thereby achieving the aim of reducing the count of scheduling. Moreover, a working dictionary and a topic set are combined, so that the situation of resource waste in an operation process may be effectively avoided, thereby increasing the operation speed of the system.

As an alternative embodiment, after a corresponding newly-added topic is extracted from the newly-added topic text queue, and before the extracted newly-added topic is added into the existing topic, the method further comprises the following step: a noise topic is filtered out from the extracted newly-added topic.

After the quantity of texts in a newly-added topic text queue reaches the number of new topics that can be extracted, because some new texts may contain a newly-added topic, some texts may have nothing to do with the current field, that is, the queue may contain noise texts, these noise texts may be texts excluding any topics or may be page advertisements having no practical significance. Herein, the number of topics contained in a text may be predicted by using a coarse clustering algorithm, and some noise texts are eliminated, so that the mining accuracy of a topic component may be ensured, and mining of useless topics may be avoided.

It should be noted that there may be multiple coarse clustering algorithms. In view of convenience for understanding and filtration of a noise text, a clustering algorithm capable of automatically determining the number of clusters such as a Density Based Clustering Algorithm (DBSCAN) may be used. This algorithm may determine the number of clusters according to a threshold, and some noise texts may be filtered. A specific flow is as follows.

(1) An object p not checked yet in a database is detected, when p is not processed (determined to pertain to a certain cluster or marked as noise), a neighbor domain thereof is checked, when the number of contained objects is not smaller than a number threshold minPts of samples in clusters, a new cluster C is set up, and all points therein are added into a candidate set N.

(2) Neighbor domains of all objects q not processed yet in a candidate set N are checked, when at least minPts objects are contained, these objects are added into N, and when q does not pertain to any cluster, q is added into C.

(3) The step (2) is repeated to continuously check non-processed objects in N, and a current candidate N is null.

(4) The steps (1) to (3) are repeated until all objects pertain to a certain cluster or are marked as noise.

By means of the embodiment of the present disclosure, a newly-added text obtained after filtration may be taken as a mining object of a newly-added topic, thereby improving the accuracy of topic mining. Moreover, when a newly-added topic in a text is discovered according to a topic model based on a noise filtration method. A manner of representing a topic by using a topic term set is more accurate than a manner of representing a topic by using text contents, and is easier to focus on a topic in a text without regard to noise information in the text.

Based on the above-mentioned implementation manner, alternatively, after the newly-added topic is added into the existing topic, the method further comprises the steps as follows. A hot topic is found from the existing topic added with the newly-added topic, wherein the hot topic is a topic of which the ranking reaches a specified threshold in the existing topic added with the newly-added topic. The hot topic is output. It should be noted that a corresponding relationship between each text and each hot topic may be considered during output of the hot topic.

After operations such as online text processing, text topic detection, text topic discovery, clustering analysis of newly-added topics and the quantity of the newly-added topics, extraction and representation of a topic model, topic dictionary update, identification and storage of text and topic attributions, selection of a tuple in a working dictionary and setting out of a tuple in a non-working dictionary are repeatedly executed, a hot topic may be output according to time limitation and hotness models, and relevant information about a dictionary and a topic is stored.

Specifically, when the quantity of texts reaches a set threshold or a program execution time reaches a preset duration, an appropriate hotness model may be selected for a topic in a current text or within a current time period to perform hot sorting. Herein, the hotness model uses the mentions of the topic, the topic duration and the topic novelty simultaneously to determine final hotness, and outputs the final hotness according to a time point, wherein a hotness calculation method is as follows: hotness=a*duration+b*mention+c*novelty+d*other factors.

Herein, duration is intended to discover those topics occurring within a long time. These topics occur within a long time steadily, usually the occurrence count is not high or may be not larger than the mention of topics occurring recently, but in view of a long time of occurrence, it serves as a hotness calculation parameter. The mention is simply interpreted as a count of occurrence of topics within a time period. Generally, a topic with higher frequency has a higher hotness. For example, when a topic occurs in a corpus (text), a great number of reports will appear in the whole internet. This topic should have a higher hotness. For example, these topics such as Tianjin explosions and Qingdao pricey prawn have high mentions within a period of time thereafter. In addition, a new topic that just occurs may not be greatly mentioned. However, this topic will tend to become a hot topic. In order to prevent information loss caused by ignoring of this topic, a concept of new novelty is introduced. Such a factor that a hot topic may be not hot enough as time flies may be added into other factors. Specifically, a relationship between the hotness of a topic and an occurrence time thereof may be set up by using a Newton cooling algorithm, so as to evolve the hotness tendency thereof.

By means of the embodiment of the present disclosure, hot topics may be more flexibly and easily sorted by using a flexible hotness calculation model, and different hotness calculation methods may be adjusted according to different application scenarios. In addition, during discovery of a text topic, an attribution relationship between a text and a topic may be marked and stored, and meanwhile, relevant information about a topic dictionary and a topic is stored, so that a text supporting a hot topic may be output whilst this hot topic is output, thereby facilitating user query.

As an alternative embodiment, the operation that it is detected whether the topic described in the newly-added text is an existing topic includes: the newly-added text is vectorized to obtain a text vector of the newly-added text. A topic matrix of the existing topic is created, wherein each column of the topic matrix represents a topic, each row represents a term in the topic, and each element represents the weight of a current term in a current topic. A function relationship Y=AX of a text vector Y of the newly-added text is constructed according to a topic matrix A of the existing topic. A belonging relationship between the topic described in the newly-added text and the existing topic is determined according to a solution of X. It is determined whether the topic described in the newly-added text is the existing topic according to the belonging relationship.

Herein, an original representation manner of a newly-added text may be flexibly selected, and will not be limited herein. After a corpus is collected, a text may be vectorized by using a TFIDF model. The TFIDF model may usually use whole network data to make statistics on a Term Frequency (TF) of a term and an inverse index value. However, in view of that different terms may have different significance in different fields or different terms have different significance and importance for understanding topic meanings, different TFIDF models may be trained for different fields. The model may be obtained by once offline training of corpuses collected in different fields previously, and a text may be vectorized repeatedly by using the model.

A main principle of the TFIDF model will be introduced below. When the TF of a certain term or phrase occurring in an article (text) is high and this term or phrase infrequently occurs in other articles, it is regarded that this term or phrase has a good class distinguishing capability and is suitable for classification. In the present disclosure, when the count of a term or phrase occurring in a topic is high and this term or phrase infrequently occurs in topics other than this topic, it is shown that this term or phrase is of significance for expression of a current topic. It should be noted that the TF means the frequency of a given term occurring in a certain text. This number is a normalization result for a term count, and can be prevented from deviating to a long file, and a calculation mode is as follows.

$${tf}_{i , j} = \frac{{n}_{i , j}}{{\sum }_{k} {n}_{k , j}}$$

where a numerator represents a count of a term j occurring in a text i, and a denominator represents the sum of counts of all terms occurring in the text.

An Inverse Document Frequency (IDF) is a measure for universal significance of a term. The IDF of a certain specific term may be obtained by dividing the number of texts containing this term by the total number of texts and then taking the logarithm for an obtained quotient.

$${idf}_{i} = log \frac{\vert D \vert}{\vert \{ j \text{:} {t}_{i} ∈ {d}_{j} \}}$$

where a numerator represents the total number of texts in a corpus, and a denominator represents the number of texts where a term i occurs. A calculation formula of TF-IDF is as follows.

tfidf_{i,j}=tf_{i,j}×idfᵢ

In the embodiment of the present disclosure, an IDF model in a current specified field may be trained, that is, an inverse index value of a text where a term occurs is calculated on a field corpus set that is large enough. After a new text occurs in this field, a TF value of the term in the text is calculated, and multiplied by an IDF value corresponding to the term to serve as one dimension after text vectorization.

During implementation, a sparse representation method may be introduced to complete topic processing for a newly-added text on line. A basic principle of sparse representation will be introduced below. In brief, it is actually an original signal factorization process. In this factorization process, a newly-added text is represented as an approximately linear function: Y=AX of a topic dictionary (also referred to as an over-complete base, in the present disclosure, the topic dictionary being quantization of an existing topic) obtained in advance, where A is a matrix corresponding to a topic dictionary, each column thereof represents a topic, each dimension of the column represents an element in this topic, and the value of the element represents importance of a term corresponding to a row where the element is located for the topic corresponding to the column. Each column in the matrix A is a vector, wherein each dimension in this vector represents a term. When the value of one dimension is zero, it is shown that this topic does not contain this term. When the value of one dimension is 0.9, it is shown that the importance of this term for a current topic is 0.9. Thus, a topic consists of a series of weighted terms actually, and these terms are quantized as a vector to occur as a tuple in a topic dictionary and a column in a dictionary matrix. Y represents a vectorized text corresponding to a newly-added text. A vector X is a linear relationship between a text and a topic, this vector is obtained by specification solving of sparse solving, most elements thereof are null, these elements may be displayed by using blank spaces during display, and other elements represent an attribution relationship with a current topic by using different color boxes. For example, a green box represents that a certain topic is contained in a text. When non-zero elements in the vector X are greater than a preset threshold, it is shown that this text is associated with a topic represented by a maximum element. In other words, this text belongs to this topic. When the maximum element is smaller than the preset threshold or the vector X is not sparse, it is shown that a relationship does not exist between this text and an existing topic, or this text is not similar to all topics discovered already, and should not pertain to any topic.

Because sparse representation is an NP problem academically and an optimal solution cannot be acquired in a direct calculation or equation solving manner, the vector X may be solved here by using an approximate solving manner of L1-norm minimization, that is, a attribution relationship between a text and a topic is solved. An L1-norm refers to the sum of all element absolute values in a vector, or lasso regularization. A theoretical research proves that on the basis of L1-norm minimization, the obtained vector also satisfies sparsity, non-zero elements in the vector are most, and therefore an X solving method is transformed into:

$${min}_{x} {‖ x ‖}_{1} + {‖ e ‖}_{2} s . t . {d}_{i} = {Ax}_{i} + e , x \geq 0$$

where x is a required vector, and e is an error of sparse representation. The purpose is to obtain a most relevant topic by solving, and to ensure that an error in a solving process is minimal. This solving process has multiple approximations, and a commonest Lasso-kit may be used for solving. Certainly, other methods may be used for solving, and will not be limited herein.

After a attribution relationship between a text and a topic is solved, the existing topic to which the text belongs can be determined, and the attribution relationship is directly marked and output. Those texts not matching existing topics may be put into a newly-added topic text queue to wait for mining a newly-added topic contained in the text during a next operation process.

An online text processing and topic discovery process will be elaborated below in conjunction with FIG. 2.

As shown in FIG. 2, a specific flow is as follows. (1) After a streaming text is acquired on line, it is input into a text representation model in the present frame, so as to represent an original text into a vectorized text. (2) It is detected whether a topic described in each vectorized text pertains to a topic currently discovered already (namely existing topic) by means of a topic discovery model. (3)

When the topic described in each vectorized text pertains to the topic currently discovered already, a relationship between a text and a topic is directly marked and output by means of a text-topic output component. (4) When the topic described in each vectorized text does not pertain to the any topic currently discovered already, it is shown that a current text contains a newly-added topic, and in this case, the text may be added into a newly-added topic text queue. (5) When the quantity of texts in the newly-added topic text queue reaches a preset threshold, a new topic mining component is started to mine a newly-added topic. (6) The newly-discovered topic is added into a current topic list by using a dictionary maintenance component, and a topic dictionary is automatically updated to make it support the newly-added topic without manual correction of a current model. In addition, after the current text is added into the newly-added topic text queue and when the quantity of texts in this queue is insufficient, a newly-added text is received continuously on line from the outside for processing whilst the texts are cached.

It should be noted that the above-mentioned frame supports online text processing. After a program is initiated, the text may be processed at any time. Moreover, the above-mentioned topic discovery model may be changed with a newly-discovered topic to achieve an adaptive topic adding mechanism. In addition, it is necessary to initialize the above-mentioned frame before executing the program. The operation includes: loading a topic discovery model, when the program is run for the first time, emptying the topic discovery model, and when the program is run not for the first time (warm start), that is a discovered topic exists, loading the existing topic into the topic discovery model; wiping all caches within a queue in the frame; and opening a text monitoring/input interface to wait for text input.

By means of the embodiment of the present disclosure, an online frame may process data acquired on the internet at any time, so that the system is more real-time. A streaming processing flow may more fully utilize system resources to increase the data processing speed.

### Embodiment 2

According to the embodiment of the present disclosure, a device embodiment of a device for processing a topic is provided.

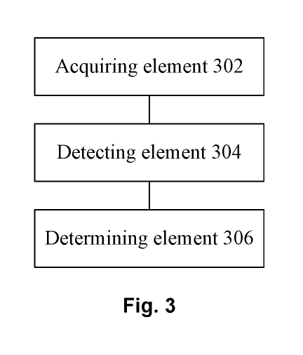

FIG. 3 is a schematic diagram of an alternative device for processing a topic according to an embodiment of the present disclosure. As shown in FIG. 2, the device includes: an acquiring element 302, configured to acquire a newly-added text for describing the topic; a detecting element 304, configured to detect whether the topic described by the newly-added text is an existing topic; and a determining element 306, configured to determine that, when a detection result is that the topic described by the newly-added text is not the existing topic, determine that the topic described by the newly-added text is a newly-added topic.

By means of the above-mentioned embodiment, a topic occurring in each information source is discovered by using an adaptive topic discovery technology, so that a new topic may be discovered and an existing topic may be traced, thereby improve the efficiency and accuracy of topic discovery.

As an alternative embodiment, the acquiring element is further configured to online acquire the newly-added text for describing the topic.

By means of the embodiment of the present disclosure, an online text acquisition mode is adopted to overcome the defect in the related art where a new topic cannot be discovered and traced in real time and a new topic event cannot be effectively understood in time due to adoption of an offline processing mode, thereby being more applicable to constantly changing working scenarios of internet information, and focusing on a topic in a text in time.

Based on the above-mentioned embodiment, alternatively, the acquiring element is further configured to acquire the newly-added text for describing a topic from a plurality kinds of information sources.

By means of the embodiment of the present disclosure, topic discovery and tracing can be achieved among multiple queries, thereby overcoming the defects in the related art where the information source is single and other effective resources such as Weibo and forums due to the fact that all pieces of information come from news reports.

As an alternative embodiment, the device further includes: a first adding element, configured to add, after it is determined that the topic described in the newly-added text is a newly-added topic, the newly-added text into the existing topic; or, a second adding element, configured to store the newly-added text for describing a topic in a newly-added topic text queue, extract, after the number of texts in the newly-added topic text queue reaches a preset value and/or a program execution time reaches a preset duration, a corresponding newly-added topic from the newly-added topic text queue, and add the extracted newly-added topic as an existing topic.

Compared with (2), (1) may update a topic dictionary storing an existing topic in time, may improve the capability of adaptively discovering and tracing a hot topic, but probably causes a large resource overhead due to over-frequent update. Compared with (1), (2) may update newly-added topics into a topic dictionary in batches, may save resource overheads occupied for update, but is insufficient in capability of topic discovery and tracing due to update lag.

As an alternative embodiment, the device further includes: a filtering element, configured to filter, after a corresponding newly-added topic is extracted from the newly-added topic text queue and before the extracted newly-added topic is added as the existing topic, a noise topic from the extracted newly-added topic.

By means of the embodiment of the present disclosure, a newly-added text obtained after filtration may be taken as a mining object of a newly-added topic, thereby improving the accuracy of topic mining. Moreover, when a newly-added topic in a text is discovered according to a topic model based on a noise filtration method. A manner of representing a topic by using a topic term set is more accurate than a manner of representing a topic by using text contents, and is easier to focus on a topic in a text without consideration of noise information in the text.

Based on the above-mentioned embodiment, as an alternative embodiment, the device further includes: a searching element, configured to, after the newly-added topic is added as the existing topic, search the existing topics added with the newly-added topic for a hot topic, wherein the hot topic is a topic of which the rank reaches a specified threshold in the existing topics added with the newly-added topic; and an outputting element, configured to output the hot topic.

By means of the embodiment of the present disclosure, hot topics may be more flexibly and easily sorted by using a flexible hotness calculation model, and different hotness calculation methods may be adjusted according to different application scenarios. In addition, during discovery of a text topic, an attribution relationship between a text and a topic may be marked and stored, and meanwhile, relevant information about a topic dictionary and a topic is stored, so that a text supporting a hot topic may be output whilst this hot topic is output, thereby facilitating user query.

As an alternative embodiment, the device further includes: a processing component, configured to vectorize the newly-added text to obtain a text vector of the newly-added text; a creating component, configured to create a topic matrix of the existing topic, wherein each column of the topic matrix represents a topic, each row represents a term in the topic, and each element represents the weight of a current term in a current topic; a constructing component, configured to construct a function relationship Y=AX of a text vector Y of the newly-added text according to a topic matrix A of the existing topic; a first determining component, configured to determine a belonging relationship between the topic described by the newly-added text and the existing topic according to a solution of X; and a second determining component, configured to determine whether the topic described by the newly-added text is the existing topic according to the belonging relationship.

It should be noted that a specific implementation manner of the device is similar to a specific implementation manner of the method, and will not be elaborated herein.

The topic processing device includes a processor and a memory. The acquiring element, the detecting element, the determining element and the like are stored in the memory as program units, and the processor executes the program units stored in the memory to achieve corresponding functions.

The processor contains a kernel, which calls a corresponding program unit from the memory. There may be one or more kernels, and text contents are analyzed by adjusting kernel parameters.

The memory may include a volatile memory, a Random Access Memory (RAM) and/or a non-volatile memory in a computer-readable medium such as a Read-Only Memory (ROM) or a flash RAM, the memory including at least one storage chip.

The present application also provides an embodiment of a computer program product. When being executed on data processing equipment, the computer program product is suitable for executing program codes initializing the following method steps: acquiring a newly-added text for describing a topic; detecting whether the topic described in the newly-added text is an existing topic; and when a detection result is that the topic described in the newly-added text is not an existing topic, determining that the topic described in the newly-added text is a newly-added topic.

The serial numbers of the embodiments of the present disclosure are only used for descriptions, and do not represent the preference of the embodiments.

In the above embodiments of the present disclosure, descriptions for each embodiment are emphasized, and parts which are not elaborated in detail in a certain embodiment may refer to relevant descriptions for other embodiments.

In several embodiments provided by the present application, it will be appreciated that the disclosed device may be implemented in another manner. Herein, the device embodiment described above is only schematic. For example, division of the units is only logic function division, and other division manners may be adopted during practical implementation. For example, multiple units or components may be combined or integrated into another system, or some characteristics may be neglected or not executed. In addition, coupling or direct coupling or communication connection between the displayed or discussed components may be indirect coupling or communication connection, implemented through some interfaces, of the units or the components, and may be electrical or adopt other forms.

The above-mentioned units described as separate parts may or may not be physically separated, and parts displayed as units may or may not be physical units, and namely may be located in the same place, or may also be distributed to multiple network units. Part or all of the units may be selected to achieve the purpose of the solutions of the present embodiment according to a practical requirement.

In addition, each function unit in each embodiment of the present application may be integrated into a processing unit, each unit may also exist independently, and two or more than two units may also be integrated into a unit. The above-mentioned integrated unit may be implemented in a form of hardware, and may also be implemented in a form of software function unit.

When being implemented in a form of software function unit and sold or used as an independent product, the integrated unit may be stored in a computer readable storage medium. Based on this understanding, the essence of the technical solution of the present disclosure or parts contributing to the related art or all or part of the technical solution may be embodied in a form of software product, the computer software product being stored in a storage medium which includes a plurality of instructions enabling computer equipment (which may be a personal computer, a server, network equipment or the like) to execute all or some of the steps of the method according to each embodiment of the present disclosure. The foregoing storage medium includes: various media capable of storing program codes, such as a U disk, a mobile hard disk, an ROM, an RAM, a magnetic disk or an optical disk.

The above is only the preferable implementation manners of the present disclosure. It should be pointed out that those of ordinary skill in the art can also make some improvements and modifications without departing from the principle of the present disclosure. These improvements and modifications should fall within the scope of protection of the present disclosure.

1. A method for processing a topic, comprising:
acquiring a newly-added text for describing the topic;
detecting whether the topic described by the newly-added text is an existing topic; and
when a detection result is that the topic described by the newly-added text is not the existing topic, determining that the topic described by the newly-added text is a newly-added topic.

2. The method as claimed in claim 1, wherein acquiring the newly-added text for describing the topic comprises:
online acquiring the newly-added text for describing the topic.

3. The method as claimed in claim 1, wherein acquiring the newly-added text for describing the topic comprises:
acquiring, from a plurality kinds of information sources, the newly-added text for describing the topic.

4. The method as claimed in claim 1, wherein after determining that the topic described by the newly-added text is the newly-added topic, the method further comprising:
adding the newly-added topic as an existing topic; or,
storing the newly-added text for describing the topic in a newly-added topic text queue, after the number of texts in the newly-added topic text queue reaches a preset value and/or a program execution time reaches a preset duration, extracting a corresponding newly-added topic from the newly-added topic text queue, and adding the extracted newly-added topic as an existing topic.

5. The method as claimed in claim 4, wherein after extracting the corresponding newly-added topic from the newly-added topic text queue and before adding the extracted newly-added topic as the existing topic, the method further comprising:
filtering a noise topic from the extracted newly-added topic.

6. The method as claimed in claim 4, wherein after adding the newly-added topic as the existing topic, the method further comprising:
searching the existing topics added with the newly-added topic for a hot topic, wherein the hot topic is a topic of which a rank reaches a preset threshold in the existing topics added with the newly-added topic; and
outputting the hot topic.

7. The method as claimed in claim 1, wherein detecting whether the topic described by the newly-added text is the existing topic comprises:
vectorizing the newly-added text to obtain a text vector of the newly-added text;
creating a topic matrix of the existing topic, wherein each column of the topic matrix represents a topic, each row represents a term in the topic, and each element represents a weight of a current term in a current topic;
constructing a function relationship Y=A*X of a text vector Y of the newly-added text according to a topic matrix A of the existing topic;
determining a belonging relationship between the topic described by the newly-added text and the existing topic according to a solution of X; and
determining whether the topic described by the newly-added text is the existing topic according to the belonging relationship.

8. A device for processing a topic, comprising:
an acquiring element, configured to acquire a newly-added text for describing the topic;
a detecting element, configured to detect whether the topic described by the newly-added text is an existing topic; and
a determining element, configured to, when a detection result is that the topic described by the newly-added text is not the existing topic, determine that the topic described by the newly-added text is a newly-added topic.

9. The device as claimed in claim 8, wherein the acquiring element is further configured to online acquire the newly-added text for describing the topic.

10. The device as claimed in claim 8, wherein the acquiring element is further configured to acquire from a plurality kinds of information sources the newly-added text for describing the topic.

11. The device as claimed in claim 8, further comprising:
a first adding element, configured to add, after it is determined that the topic described by the newly-added text is the newly-added topic, the newly-added text as an existing topic; or,
a second adding element, configured to store the newly-added text for describing the topic in a newly-added topic text queue, extract, after the number of texts in the newly-added topic text queue reaches a preset value and/or a program execution time reaches a preset duration, a corresponding newly-added topic from the newly-added topic text queue, and add the extracted newly-added topic as an existing topic.

12. The device as claimed in claim 11, further comprising:
a filtering element, configured to filter, after the corresponding newly-added topic is extracted from the newly-added topic text queue and before the extracted newly-added topic is added as the existing topic, a noise topic from the extracted newly-added topic.

13. The device as claimed in claim 11, further comprising:
a searching element, configured to, after the newly-added topic is added as the existing topic, search the existing topics added with the newly-added topic for a hot topic, wherein the hot topic is a topic of which a rank reaches a preset threshold in the existing topics added with the newly-added topic; and
an outputting element, configured to output the hot topic.

14. The device as claimed in claim 8, wherein the detecting element comprises:
a processing component, configured to vectorize the newly-added text to obtain a text vector of the newly-added text;
a creating component, configured to create a topic matrix of the existing topic, wherein each column of the topic matrix represents a topic, each row represents a term in the topic, and each element represents a weight of a current term in a current topic;
a creating component, configured to create a topic matrix of the existing topic, wherein each column of the topic matrix represents a topic, each row represents a term in the topic, and each element represents a weight of a current term in a current topic;
a first determining component, configured to determine a belonging relationship between the topic described by the newly-added text and the existing topic according to a solution of X; and
a second determining component, configured to determine whether the topic described by the newly-added text is the existing topic according to the belonging relationship.

15. The method as claimed in claim 2, wherein acquiring the newly-added text for describing the topic comprises:
acquiring, from a plurality kinds of information sources, the newly-added text for describing the topic.

16. The method as claimed in claim 5, wherein after adding the newly-added topic as the existing topic, the method further comprising:
searching the existing topics added with the newly-added topic for a hot topic, wherein the hot topic is a topic of which a rank reaches a preset threshold in the existing topics added with the newly-added topic; and
outputting the hot topic.

17. The device as claimed in claim 9, wherein the acquiring element is further configured to acquire from a plurality kinds of information sources the newly-added text for describing the topic.

18. The device as claimed in claim 12, further comprising:
a searching element, configured to, after the newly-added topic is added as the existing topic, search the existing topics added with the newly-added topic for a hot topic, wherein the hot topic is a topic of which a rank reaches a preset threshold in the existing topics added with the newly-added topic; and
an outputting element, configured to output the hot topic.

19. Data processing equipment, comprising:
at least one processor; and
a computer readable storage, coupled to the at least one processor and storing at least one computer executable instructions thereon, which when the at least one computer executable instructions is executed by the at least one processor, cause the at least one processor to carry out actions in the method as claimed in claim 1.

20. A non-transitory computer-readable storage medium, on which a computer program is stored, wherein the computer program is executed by a processor to carry out actions in the method as claimed in claim 1.
